(19) United States
(12) Patent Application Publication
(10) Pub. No.: US 2023/0035197 A1
(43) Pub. Date: Feb. 2, 2023

(54) METHODS AND APPARATUS TO PREDICT AN IMPACT OF A SOURCE CODE CHANGE ON A CLOUD INFRASTRUCTURE

(71) Applicant: VMware, Inc., Palo Alto, CA (US)

(72) Inventors: Adam Schepis, Boston, MA (US); Vikram Pillai, Boston, MA (US); Taylor Bruce, Boston, MA (US); Rob Curtis, Boston, MA (US); Stephen Morin, Boston, MA (US); Tammy Steffen, San Francisco, CA (US)

(21) Appl. No.: 17/588,060

(22) Filed: Jan. 28, 2022

Related U.S. Application Data
(60) Provisional application No. 63/203,646, filed on Jul. 27, 2021.

(51) Int. Cl. G06F 9/50; G06F 9/445; G06F 8/51

(52) U.S. Cl. CPC G06F 9/5072; G06F 9/44505; G06F 8/51

(57) ABSTRACT

Methods, apparatus, systems, and articles of manufacture to determine an impact of a source code change on a cloud infrastructure are disclosed. One such system includes an infrastructure difference identifier to identify a difference between a proposed cloud infrastructure and an existing cloud infrastructure, and an infrastructure analyzer to (i) identify new infrastructure equipment to be added to the existing infrastructure based on the infrastructure modification, (ii) obtain identities some of the new infrastructure equipment that are candidates for right-sizing based on an infrastructure equipment grouping into which some of the new infrastructure equipment is to be placed, (iii) obtain information identifying a cost associated with different infrastructure equipment to deploy in place of the candidates, the different infrastructure equipment being right-sized for the grouping; and (iv) generate a report identifying an amount of savings that can be achieved by deploying the different infrastructure equipment in place of the new infrastructure equipment.

### RELATED APPLICATION

This patent claims the benefit of U.S. Provisional Patent Application No. 63/203,646 which was filed on Jul. 27, 2021. U.S. Provisional Patent Application No. 63/203,646 is hereby incorporated herein by reference in its entirety. Priority to U.S. Provisional Patent Application No. 63/203,646 is hereby claimed.

### FIELD OF THE DISCLOSURE

This disclosure relates generally to cloud infrastructure and, more particularly, to methods and apparatus to predict impact of a source code change on a cloud infrastructure.

### BACKGROUND

The speed and scale of cloud-native development is moving the industry to a decentralized model in which teams and developers hold more power and responsibility for the management of their cloud infrastructure than ever before.

### BRIEF DESCRIPTION OF THE DRAWINGS

FIG. 1 is a block diagram of a system including a cloud platform to predict impact of a source code change on cloud infrastructure according to the teaching disclosed herein.

FIG. 2 is flowchart representative of example machine readable instructions that may be executed by example processor circuitry to implement the system of FIG. 1.

FIG. 3 is flowchart representative of example machine readable instructions that may be executed by example processor circuitry to implement the system of FIG. 1.

FIG. 4 is a block diagram of an example processing platform including processor circuitry structured to execute the example machine readable instructions of FIG. 2 and FIG. 3 to implement the cloud platform of FIG. 1.

FIG. 5 is a block diagram of an example implementation of the processor circuitry of FIG. 4.

FIG. 6 is a block diagram of another example implementation of the processor circuitry of FIG. 4.

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

As cloud management continues to shift to a decentralized model in which teams and developers hold more power and responsibility for the management of their cloud infrastructure, developers need to know the impact of the changes they are making in real-time using the tools they already know prior to changes being deployed into production and having unintended consequence.

Increasingly modern cloud infrastructure layout is controlled using configuration files managed in source control systems using a paradigm called “infrastructure as code.” Methods, apparatus, systems and articles of manufacture disclosed herein propose inspecting source code changes prior to merging the source code changes in into production code, analyzes the source code changes, compare the source code changes against data and trends for target infrastructure that the source code would impact and make projections (cost, performance), and recommendations (rightsizing, governance, compliance) based on the presumed or inferred impact of the changes. Thus, the methods, apparatus, and systems disclosed herein may determine the cost of the impact of a source code change that may result in, for example a security lapse (which causes loss in money, time, and reputation) and may also compare those costs to achieve a more efficient infrastructure and/or to determine a right-sized set of servers. As such, the methods, apparatus, systems and articles of manufacture disclosed herein are able to assess an impact of a proposed source code change in a cloud environment holistically.

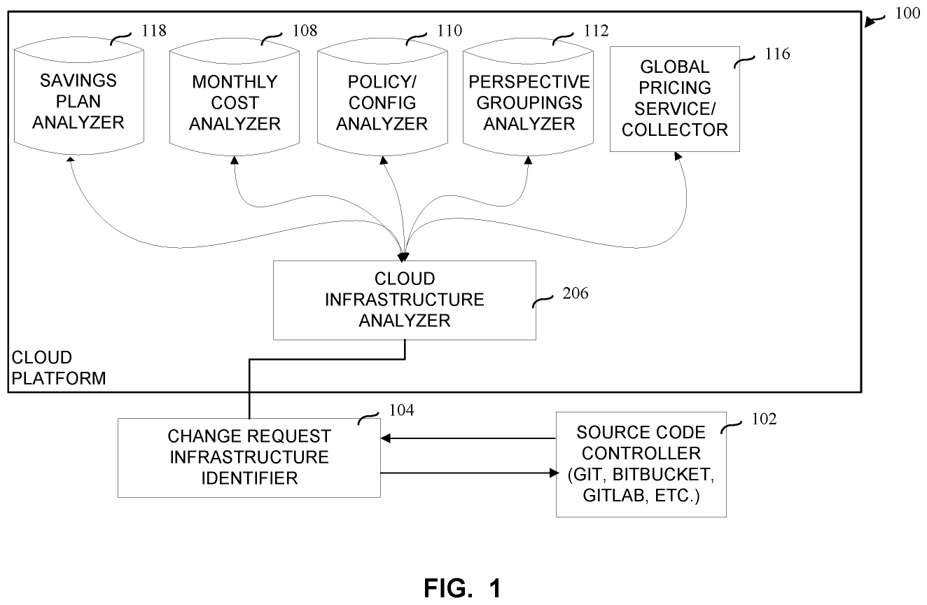

FIG. 1 is a block diagram of a system for identifying one or more impacts that will results from a source code change. In some examples, the source code represents source code that, when executed, configures infrastructure of a client/tenant of a cloud computing system. As used herein the tenant infrastructure refers to the infrastructure of a portion of the cloud infrastructure used by the tenant. In some examples, the system 100 of FIG. 1 includes an example source code controller 102, an example change request infrastructure identifier 104, an example cloud infrastructure analyzer 106, an example monthly cost analyzer 108, an example policy/configuration analyzer 110, an example infrastructure groupings identifier 212, an example global pricing service/collector 116 and an example savings plan analyzer 118.

In some examples, a tenant determines that changes are to be made to source code that affects a tenant's cloud deployment. The source code file to be changed is accompanied by an infrastructure configuration file that identifies the underlying infrastructure to be deployed in support of the source code. As a result, changes to the source code file result in a new infrastructure configuration file. The example infrastructure source code controller 102 supplies the new infrastructure configuration file and an existing infrastructure configuration file representing the existing, current infrastructure to the example change request infrastructure identifier 104. The change request infrastructure identifier 104 operates to compare the new infrastructure configuration file to the existing infrastructure configuration file. The comparison yields difference information identifying differences between the existing infrastructure and the new infrastructure. In some examples, the difference information indicates that existing infrastructure equipment is to be removed or that new infrastructure equipment is to be added. In some examples, the difference information is referred to as an infrastructure modification. In some examples, the infrastructure modification information is supplied to the example cloud platform. The difference information can be transmitted directly to the cloud infrastructure analyzer 106 of the cloud platform, can be stored in a memory accessible to the cloud infrastructure analyzer 106, retrieved by the cloud infrastructure analyzer 106 or in any other way.

In some examples, difference information identifies specific aspects, devices, servers, load balancers, storage devices, workloads, etc. that will be affected by (involved in) the infrastructure change. As used herein, the specific aspects, compute devices, servers, load balancers, storage devices, workloads, etc. that are included in the difference information are referred to as changed equipment. As used herein, the difference information can include a listing of equipment to be removed and/or equipment to be added, both of which are referred to as changed equipment.

The example cloud infrastructure analyzer 106 analyzes the difference information to determine/predict any impact the requested infrastructure change will have on the existing tenant infrastructure in terms of pricing/cost, configuration, policies, etc. In some such examples, the cloud infrastructure analyzer 106 accesses the capabilities of the example global pricing service/collector 116, the example infrastructure groupings analyzer 112, the example policy/configuration analyzer 110 and/or the example monthly cost analyzer 108. Any or all of the global pricing service/collector 116, the infrastructure groupings analyzer 112, the policy/configuration analyzer 110 and the monthly cost analyzer 108 can operate in parallel or in serial depending on any number of variants including characteristics of the difference information, characteristics of the tenant's deployment, characteristics of the operation of the cloud infrastructure analyzer 106, etc. In some examples, the cloud infrastructure analyzer 106 causes one or more of the global pricing service/collector 116, the infrastructure groupings analyzer 112, the policy/configuration analyzer 110 and the monthly cost analyzer 108 to operate in iterative fashion until one or more target objectives are met. In some such examples, the cloud infrastructure analyzer 106 can be configured to achieve a specific cost objective, a specific efficiency objective, a policy objective, etc. In some examples, the global pricing service/collector 116, the infrastructure groupings analyzer 112, the policy/configuration analyzer 110 and the monthly cost analyzer 108 operate to process information output by any of the other ones of the global pricing service/collector 116, the infrastructure groupings analyzer 112, the policy/configuration analyzer 110 and the monthly cost analyzer 108.

In some examples, the difference information identifies equipment to be added to the tenant infrastructure. In some such examples, the example cloud infrastructure analyzer 106 accesses the global pricing service/collector 116 to determine a cost associated with purchase/rental of the additional equipment. In some examples, the difference information identifies infrastructure equipment that can be down-sized (e.g., replaced with infrastructure equipment having lesser capabilities than the existing infrastructure equipment) or eliminated from the tenant cloud infrastructure in light of the infrastructure change to be implemented. In some such examples, the example cloud infrastructure analyzer 106 causes the global pricing service/collector 116 to operate to determine a cost associated with purchase/rental of the infrastructure equipment that is less expensive than the existing infrastructure equipment, or that is associated with the removal of infrastructure equipment from the tenant infrastructure or that is additional to the infrastructure equipment. In some examples, the global pricing service/collector 116 has access to equipment costs provided by, for example, a cloud operator, or any third party provider. In some examples, the global pricing service/collector 116 supplies the cost information to the example cloud infrastructure analyzer 106. In some examples, the cost information is supplied on an itemized basis.

Assuming, in some examples, the difference information identifies equipment to be added to the tenant infrastructure, the example cloud infrastructure analyzer 106 accesses the capabilities of the example infrastructure groupings analyzer 112 to analyze one or more of a set of equipment groups to which the additional equipment is to be assigned. In some such examples, the tenant infrastructure includes equipment that is grouped together according to any of a variety of characteristics, including a type of workload performed by the equipment included in a group, a type of data traffic handled by the equipment in a group, a speed at which equipment included in a group is to operate, etc. In some examples, a group of equipment can be associated with a same tag (or other identifier) to thereby associate the equipment with the group.

In some examples, a first group of equipment of an existing tenant infrastructure can function to handle web traffic and, as such, the equipment assigned to the group need not be capable of performing processing or memory intensive tasks. Another such second group of equipment can function to handle data pipeline processing tasks associated with a backend system, and, as such, equipment assigned to the second group is to have the capability to perform data intensive and memory intensive tasks at an accelerated speed.

In some examples, the example infrastructure groupings analyzer 112 determines a grouping(s) to which any additional equipment is to be assigned (in light of the type of the additional equipment and tags associated therewith). In some such examples, the infrastructure groupings analyzer 112 determines if any of the infrastructure assets (also referred to as equipment) included in that group can be right-sized. Right-sizing refers to reserving cloud infrastructure with assets (RAM, CPU, storage, network) having capabilities that are sufficient to perform assigned workloads at the lowest cost possible (or at least at a lower cost compared to other available assets). For example, when/if the assets/equipment assigned to a group can be right-sized to a different size/instance the infrastructure groupings analyzer 112 determines what such a different size/instance is appropriate for the group. In some examples, the infrastructure groupings analyzer 112 informs the cloud infrastructure analyzer 106 of the differently size/instance of the equipment that will achieve the desired right-sizing.

In some examples, the example cloud infrastructure analyzer 106 informs the example global pricing service/collector 116 of the potential to right-size one or more of the infrastructure assets/equipment. The global pricing service/collector 116 identifies a cost(s) associated with the recommended differently-sized instance of the equipment. The cloud infrastructure analyzer 106 can compare the cost of the recommended, differently-sized assets/instance from (or to) a cost of the originally recommended infrastructure equipment (i.e., the equipment recommended prior to the identification of the right-sized infrastructure equipment) to determine a difference between the two costs. In this manner, the global pricing service/collector 116 determines a potential cost savings, if any, associated with selecting the right-sized equipment. The global pricing service/collector 116 supplies the potential cost savings to the cloud infrastructure analyzer 106.

In some examples, the example cloud infrastructure analyzer 106 provides itemized cost information (with and/or without taking into consideration the right-sizing cost information) to the example savings plan analyzer 118. The savings plan analyzer 118 uses the supplied cost information to determine an extent (for example, as a percentage) to which the additional infrastructure, if purchased/rented, will be covered by an existing savings plan agreement between the cloud tenant and the cloud operator. The pricing agreement identifies agreed upon rental prices for the infrastructure equipment (e.g., a negotiated cost for using a piece of infrastructure equipment on an hourly basis). The extent of coverage is used to determine costs associated with adding the additional equipment that is not covered in the savings plan agreement. The costs associated with the additional equipment not included in the savings plan can be reported by the savings plan analyzer 118 to the cloud infrastructure analyzer 106. In some examples, the rental of the additional equipment results in greater savings on an operating cost/hour basis (e.g., the operating cost/hour decreases as more infrastructure is included in the tenant's infrastructure.

The example cloud infrastructure analyzer 106 consults the monthly cost analyzer 108 to determine a monthly cost currently paid by the tenant for the tenant's existing infrastructure equipment. In some examples, the monthly cost analyzer 108 can be implemented using an OLAP report generator. The cloud infrastructure analyzer 106 can then compare the currently monthly costs to a revised monthly cost that will be owed in the event that the infrastructure change is undertaken. In some examples, the cloud infrastructure analyzer 106 further identifies any costs that will result from selecting a right-sizing option and the savings that will result (or not) based on the existing savings plan agreement. In some examples, the cloud infrastructure analyzer 106 provides an itemized report of the affected infrastructure (to be added or removed) and/or any number of additional cost savings that will be realized if the infrastructure change request is implemented.

In some examples, the example cloud infrastructure analyzer 106 supplies the example difference information to the example policy/configuration analyzer 110 which responds to the infrastructure change information by determining whether any of the equipment of the new infrastructure (if implemented) will violate any existing tenant policies. In some examples, existing tenant policies indicate rules that are to be met by the existing infrastructure and, if implemented, the new infrastructure equipment. Such policies are determined by the tenant and supplied to the policy/configuration analyzer 110 by an infrastructure administrator associated with the tenant. An example policy may require that all infrastructure equipment be tagged with information that can be used to identify an owner of the equipment. The owner of the equipment in this context refers to a group (or user) within the tenant organization that uses the equipment. In some examples, the information included in the tag can be used to contact the owner for questions regarding the equipment. Another example policy may require infrastructure exceeding a specific cost per month be terminated. Another example policy may require infrastructure to be configured such that specific network ports are not open to specific types of network traffic.

In some examples, the blocks of FIG. 1 may be referred to as means for determining includes means analyzing cloud infrastructure, means for determining equipment costs, means for analyzing policies, means for determining revised monthly costs, means for analyzing infrastructure groupings, means for performing right sizing means for analyzing a savings plan, means for determining a change in monthly costs, means to identify an infrastructure change, and means for identifying a configuration file corresponding to a source code file.

With respect to the system of FIG. 1, one or more of the elements, processes, and/or devices illustrated in FIG. 1 may be combined, divided, re-arranged, omitted, eliminated, and/or implemented in any other way. Further, the example source code controller 102, the example change request infrastructure identifier 104, the example cloud infrastructure analyzer 106, the example monthly cost analyzer 108, the example policy/configuration analyzer, the example groupings identifier and the example global pricing service/collector 116, and/or more generally the example system of FIG. 1, may be implemented by hardware, software, firmware, and/or any combination of hardware, software, and/or firmware. Thus, for example, any of the example source code controller 102, the example change request infrastructure identifier 104, the example cloud infrastructure analyzer 106, the example monthly cost analyzer 108, the example policy/configuration analyzer, the example groupings identifier and the example global pricing service/collector 116, and/or more generally the example system of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example source code controller 102, the example change request infrastructure identifier 104, the example cloud infrastructure analyzer 106, the example monthly cost analyzer 108, the example policy/configuration analyzer, the example groupings identifier and the example global pricing service/collector 116, and/or more generally the example system of FIG. 1 is/are hereby expressly defined to include a non-transitory computer readable storage device or storage disk such as a memory, a digital versatile disk (DVD), a compact disk (CD), a Blu-ray disk, etc., including the software and/or firmware. Further still, the example system of FIG. 1 may include one or more elements, processes, and/or devices in addition to, or instead of, those illustrated in FIG. 1, and/or may include more than one of any or all of the illustrated elements, processes and devices.

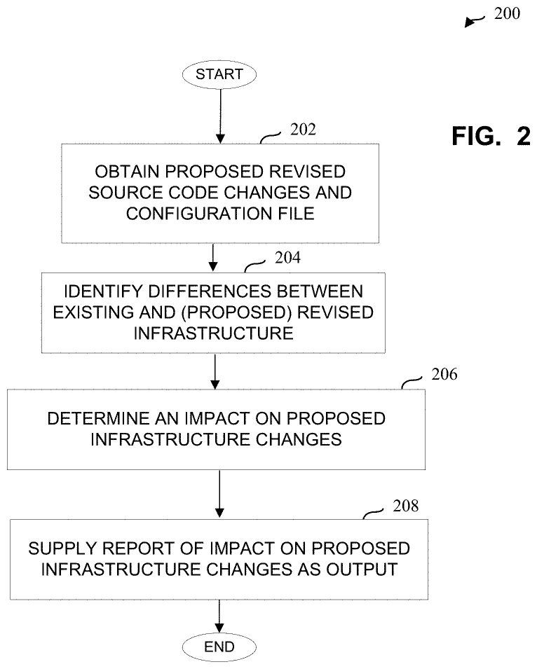

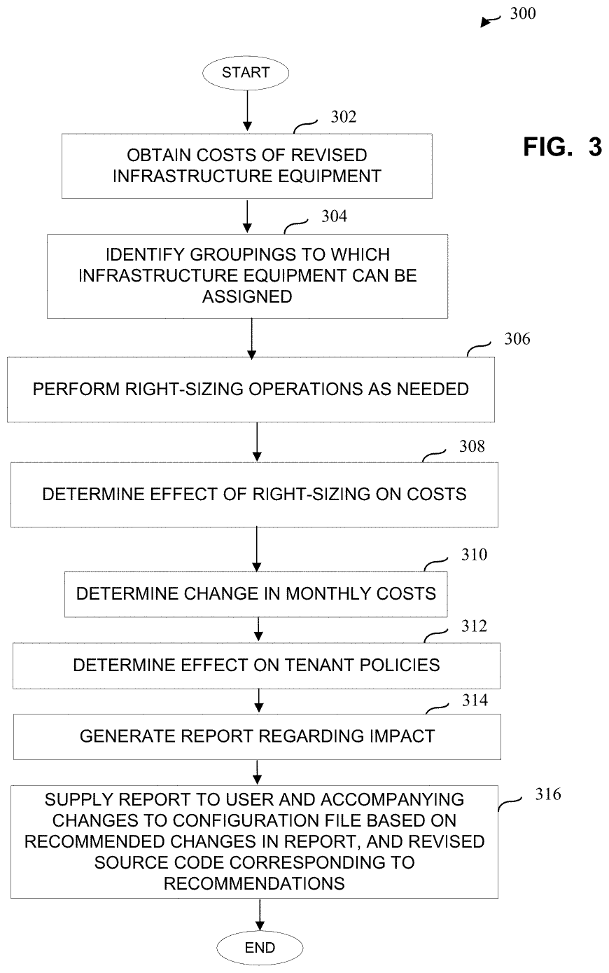

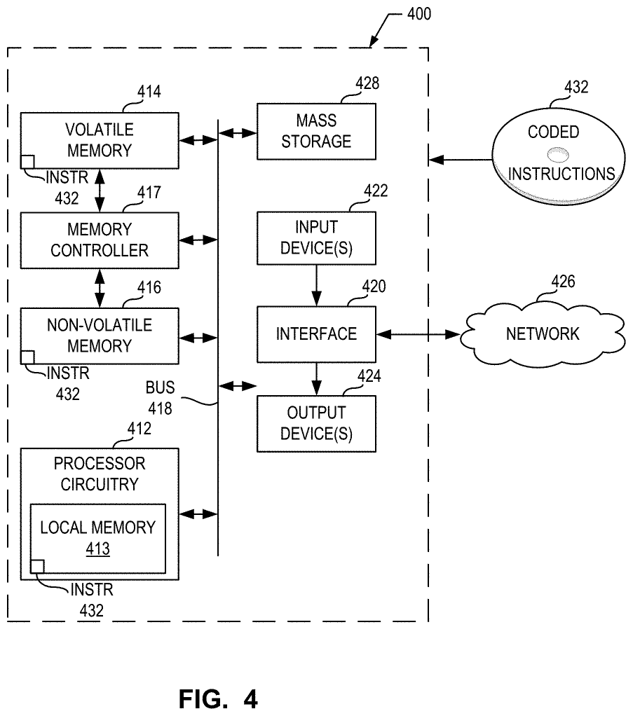

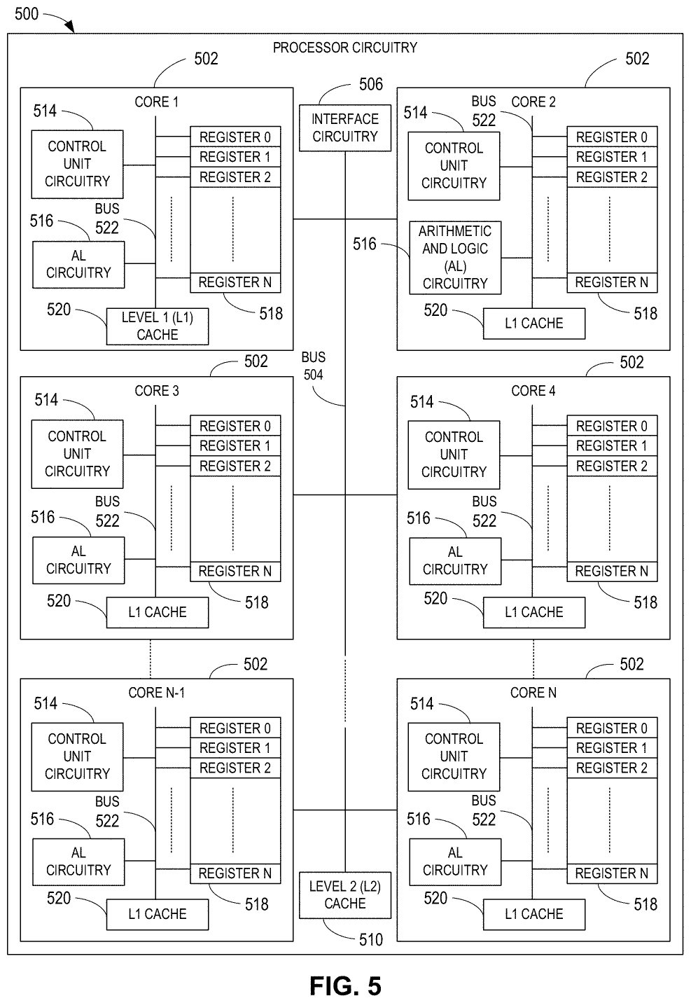

A flowchart representative of example hardware logic circuitry, machine readable instructions, hardware implemented state machines, and/or any combination thereof for implementing the system of FIG. 1 is shown in FIG. 2 and FIG. 3. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example programs are described with reference to the flowchart illustrated in FIG. 2 and FIG. 3, many other methods of implementing the example system 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2 and 3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 200 that may be executed and/or instantiated by processor circuitry to predict an impact of a source code change on a cloud infrastructure. The machine readable instructions and/or operations 200 of FIG. 2 begin at block 202, at which the example source code controller 102 operates on information (provided, for example, by a cloud tenant) indicating that an impact on cloud infrastructure is be determined based on changes to the infrastructure that are under consideration. In some examples, a cloud tenant determines one or more changes to be made to source code, which, when executed, will affect a tenant's cloud deployment. The source code file to be changed is accompanied by an infrastructure configuration file that identifies the underlying infrastructure to be deployed in support of the source code. As a result, changes to the source code file result in a new infrastructure configuration file.

At block 204, the example infrastructure source code controller 102 supplies the new infrastructure configuration file and an existing infrastructure configuration file representing the existing, current infrastructure to the example change request infrastructure identifier 104. The change request infrastructure identifier 104 operates to compare the new infrastructure configuration file to the existing infrastructure configuration file. The comparison yields difference information identifying differences between the existing infrastructure and the new infrastructure. In some examples, the difference information indicates that existing infrastructure equipment is to be removed or that new infrastructure equipment is to be added. In some examples, the difference information is supplied to the example cloud platform. The difference information can be transmitted directly to the cloud infrastructure analyzer 106 of the cloud platform, can be stored in a memory accessible to the cloud infrastructure analyzer 106, retrieved by the cloud infrastructure analyzer 106 or in any other way.

In some examples, difference information identifies specific aspects, devices, servers, load balancers, storage devices, workloads, etc. that will be affected by (involved in) the infrastructure change. As used herein, the specific aspects, compute devices, servers, load balancers, storage devices, workloads, etc. that are included in the difference information are referred to as changed equipment. As used herein, the difference information can include a listing of equipment to be removed and/or equipment to be added, both of which are referred to as changed equipment.

At a block 206, the example cloud infrastructure analyzer 106 analyzes the difference information to determine/predict any impact the requested infrastructure change will have on the existing tenant infrastructure in terms of pricing/cost, configuration, policies, etc. In some such examples, the cloud infrastructure analyzer 106 accesses the capabilities of the example global pricing service/collector 116, the example infrastructure groupings analyzer 112, the example policy/configuration analyzer 110 and/or the example monthly cost analyzer 108. Any or all of the global pricing service/collector 116, the infrastructure groupings analyzer 112, the policy/configuration analyzer 110 and the monthly cost analyzer 108 can operate in parallel or in serial depending on any number of variants including characteristics of the difference information, characteristics of the tenant's deployment, characteristics of the operation of the cloud infrastructure analyzer 106, etc. In some examples, the cloud infrastructure analyzer 106 causes one or more of the global pricing service/collector 116, the infrastructure groupings analyzer 112, the policy/configuration analyzer 110 and the monthly cost analyzer 108 to operate in iterative fashion until one or more target objectives are met. In some such examples, the cloud infrastructure analyzer 106 can be configured to achieve a specific cost objective, a specific efficiency objective, a policy objective, etc. In some examples, the global pricing service/collector 116, the infrastructure groupings analyzer 112, the policy/configuration analyzer 110 and the monthly cost analyzer 108 operate to process information output by any of the other ones of the global pricing service/collector 116, the infrastructure groupings analyzer 112, the policy/configuration analyzer 110 and the monthly cost analyzer 108. At a block 208, the cloud infrastructure analyzer 106 generates one or more reports identifying the impact of the changes to the infrastructure to be supplied as an output. Thereafter, the method 200 ends.

FIG. 3 is a flowchart representative of example machine readable instructions and/or example operations 300 that may be executed and/or instantiated by processor circuitry to analyze the effects of a source code change on a tenant infrastructure. The machine readable instructions and/or operations 300 of FIG. 3 begin at block 302, at which example cloud infrastructure analyzer 106 accesses the global pricing service/collector 116 to determine a cost associated with purchase/rental of the additional equipment. In some examples, the difference information identifies existing infrastructure equipment that can be down-sized (e.g., replaced with infrastructure equipment having lesser capabilities than the existing infrastructure equipment) or eliminated from the infrastructure in light of the infrastructure change to be implemented. In some such examples, the example cloud infrastructure analyzer 106 causes the global pricing service/collector 116 to operate to determine a cost associated with purchase/rental of the infrastructure equipment that is less expensive than the existing infrastructure equipment, or that is associated with the removal of infrastructure equipment from the tenant infrastructure or that is additional to the infrastructure equipment. In some examples, the global pricing service/collector 116 has access to equipment costs provided by, for example, a cloud operator, or any third party provider. In some examples, the global pricing service/collector 116 supplies the cost information to the example cloud infrastructure analyzer 106. In some examples, the cost information is supplied on an itemized basis.

At a block 304, in some examples, the difference information identifies equipment to be added to the tenant infrastructure. In some such examples, the example cloud infrastructure analyzer 106 accesses the capabilities of the example infrastructure groupings analyzer 112 to analyze one or more of a set of equipment groups to which the additional equipment is to be assigned. In some such examples, the tenant infrastructure includes equipment that is grouped together according to any of a variety of characteristics, including a type of workload performed by the equipment included in a group, a type of data traffic handled by the equipment in a group, a speed at which equipment included in a group is to operate, etc. In some examples, a group of equipment can be associated with a same tag (or other identifier) to thereby associate the equipment with the group.

In some examples, a first group of equipment of an existing tenant infrastructure can function to handle web traffic and, as such, the equipment assigned to the group need not be capable of performing processing or memory intensive tasks. Another such second group of equipment can function to handle data pipeline processing tasks associated with a backend system, and, as such, equipment assigned to the second group is to have the capability to perform data intensive and memory intensive tasks at an accelerated speed.

In some examples, the example infrastructure groupings analyzer 112 determines a grouping(s) to which any additional equipment is to be assigned (in light of the type of the additional equipment and tags associated therewith).

At a block, 306, the example infrastructure groupings analyzer 112 determines if any of the infrastructure assets (also referred to as equipment) included in that group can be right-sized. Right-sizing refers to reserving cloud infrastructure with assets (RAM, CPU, storage, network) having capabilities that sufficient to perform an assigned workloads at the lowest cost possible (or at least at a lower cost compared to other available assets). For example, when/if the assets/equipment assigned to a group can be right-sized to a different size/instance the infrastructure groupings analyzer 112 determines what such a different size/instance is appropriate for the group. In some examples, the infrastructure groupings analyzer 112 informs the cloud infrastructure analyzer 106 of the differently size/instance of the equipment that will achieve the desired right-sizing.

At a block 308, the example cloud infrastructure analyzer 106 informs the example global pricing service/collector 116 of the potential to right-size one or more of the infrastructure assets/equipment. The global pricing service/collector 116 identifies a cost(s) associated with the recommended differently-sized instance of the equipment. The cloud infrastructure analyzer 106 can compare the cost of the recommended, differently-sized assets/instance from (or to) a cost of the originally recommended infrastructure equipment (i.e., the equipment recommended prior to the identification of the right-sized infrastructure equipment) to determine a difference between the two costs. In this manner, the global pricing service/collector 116 determines a potential cost savings, if any, associated with selecting the right-sized equipment. The global pricing service/collector 116 supplies the potential cost savings to the cloud infrastructure analyzer 106.

At a block 310, the example cloud infrastructure analyzer 106 provides itemized cost information (with and/or without taking into consideration the right-sizing cost information) to the example savings plan analyzer 118. The savings plan analyzer 118 uses the supplied cost information to determine an extent (for example, as a percentage) to which the additional infrastructure, if purchased/rented, will be covered by an existing savings plan agreement between the cloud tenant and the cloud operator. The pricing agreement identifies agreed upon rental prices for the infrastructure equipment (e.g., a negotiated cost for using a piece of infrastructure equipment on an hourly basis). The extent of coverage is used to determine costs associated with adding the additional equipment that is not covered in the savings plan agreement. The costs associated with the additional equipment not included in the savings plan can be reported by the savings plan analyzer 118 to the cloud infrastructure analyzer 106. In some examples, the rental of the additional equipment results in greater savings on an operating cost/hour basis (e.g., the operating cost/hour decreases as more infrastructure is included in the tenant's infrastructure.

At a block 310, the example cloud infrastructure analyzer 106 consults the monthly cost analyzer 108 to determine a monthly cost currently paid by the tenant for the tenant's existing infrastructure equipment. The cloud infrastructure analyzer 106 can then compare the currently monthly costs to a revised monthly cost that will be owed in the event that the infrastructure change is undertaken. In some examples, the cloud infrastructure analyzer 106 further identifies any costs that will result from selecting a right-sizing option and the savings that will result (or not) based on the existing savings plan agreement. In some examples, the cloud infrastructure analyzer 106 provides an itemized report of the affected infrastructure (to be added or removed) and/or any number of additional cost savings that will be realized if the infrastructure change request is implemented.

At a block 312, the example cloud infrastructure analyzer 106 supplies the example difference information to the example policy/configuration analyzer 110 which responds to the infrastructure change information by determining whether any of the equipment of the new infrastructure (if implemented) will violate any existing tenant policies. In some examples, existing tenant policies indicate rules that are to be met by the existing infrastructure and, if implemented, the new infrastructure equipment. Such policies are determined by the tenant and supplied to the policy/configuration analyzer 110 by an infrastructure administrator associated with the tenant. An example policy may require that all infrastructure equipment be tagged with information that can be used to identify an owner of the equipment. The owner of the equipment in this context refers to a group (or user) within the tenant organization that uses the equipment. In some examples, the information included in the tag can be used to contact the owner for questions regarding the equipment. Another example policy may require infrastructure exceeding a specific cost per month be terminated. Another example policy may require infrastructure to be configured such that specific network ports are not open to specific types of network traffic.

At a block 314, the example cloud infrastructure analyzer 106 uses the information supplied by any or all of the example global pricing service/collector 116, the example infrastructure groupings analyzer 112, the example policy/configuration analyzer 110, the example monthly cost analyzer 108, the example savings plan analyzer 118, etc., to generate a report.

At a block 316, the example change request infrastructure identifier 104 uses the report and/or other information supplied to the change request infrastructure identifier 104 to generate any additional reports and to supply the reports to the user along with accompanying changes to the configuration file based on changes recommended in cloud infrastructure report. The change request infrastructure 104 and/or the source code controller 102 can generate revised source code that could be used implement the changes recommended in the cloud infrastructure report. Thereafter the method 300 ends.

FIG. 4 is a block diagram of an example processor platform 400 structured to execute and/or instantiate the machine readable instructions and/or operations of FIG. 2 and FIG. 3 to implement the system of FIG. 1. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements the example source code controller 102, the example change request infrastructure identifier 104, the example cloud infrastructure analyzer 106, the example monthly cost analyzer 108, the example policy/configuration analyzer, the example groupings identifier and the example global pricing service/collector 116.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 424 are also connected to the interface circuitry 420 of the illustrated example. The output devices 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 432, which may be implemented by the machine readable instructions of FIG. 2 and FIG. 3 may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may implement multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIG. 2 and FIG. 3.

The cores 502 may communicate by an example bus 504. In some examples, the bus 504 may implement a communication bus to effectuate communication associated with one(s) of the cores 502. For example, the bus 504 may implement at least one of an Inter-Integrated Circuit (I2C) bus, a Serial Peripheral Interface (SPI) bus, a PCI bus, or a PCIe bus. Additionally, or alternatively, the bus 504 may implement any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2_cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the L1 cache 520, and an example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The bus 520 may implement at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

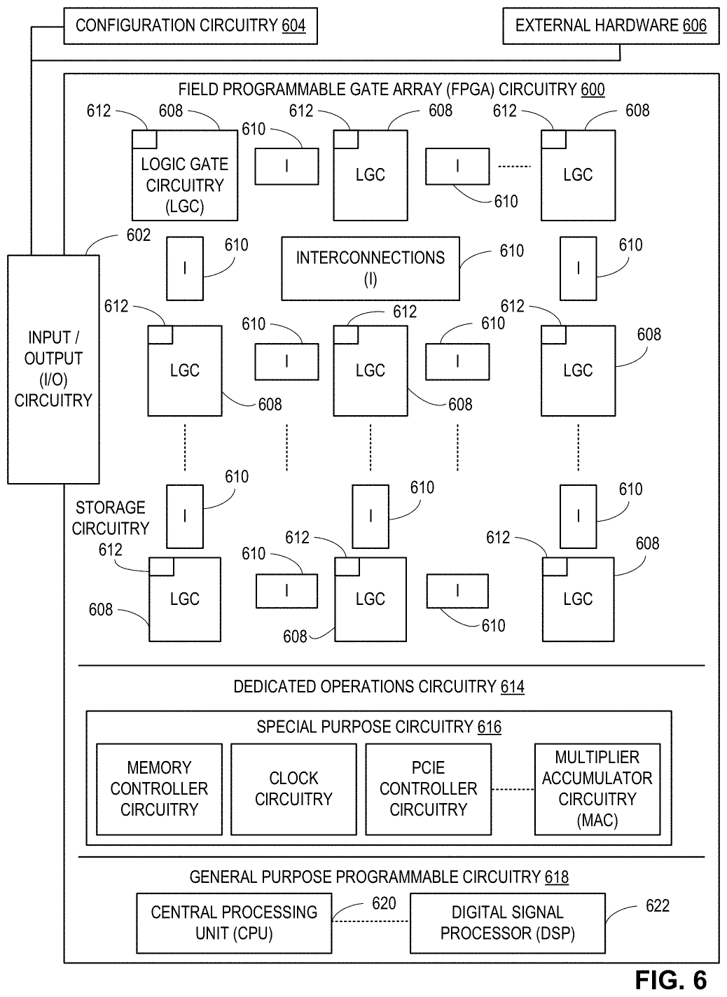

FIG. 6 is a block diagram of another example implementation of the processor circuitry 412 of FIG. 4. In this example, the processor circuitry 412 is implemented by FPGA circuitry 600. The FPGA circuitry 600 can be used, for example, to perform operations that could otherwise be performed by the example microprocessor 600 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowcharts of FIG. 2 and FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowcharts of FIG. 2 and FIG. 3. In particular, the FPGA 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowcharts of FIG. 2 and FIG. 3. As such, the FPGA circuitry 600 may be structured to effectively instantiate some or all of the machine readable instructions of the flowcharts of FIG. 2 and FIG. 3 as dedicated logic circuits to perform the operations corresponding to those software instructions in a dedicated manner analogous to an ASIC. Therefore, the FPGA circuitry 600 may perform the operations corresponding to the some or all of the machine readable instructions of FIG. 2 and FIG. 3 faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware (e.g., external hardware circuitry) 606. For example, the configuration circuitry 604 may implement interface circuitry that may obtain machine readable instructions to configure the FPGA circuitry 600, or portion(s) thereof. In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may implement the microprocessor 500 of FIG. 5. The FPGA circuitry 600 also includes an array of example logic gate circuitry 608, a plurality of example configurable interconnections 610, and example storage circuitry 612. The logic gate circuitry 608 and interconnections 610 are configurable to instantiate one or more operations that may correspond to at least some of the machine readable instructions of FIG. 2 and FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowcharts of FIG. 2 and FIG. 3 may be executed by one or more of the cores 502 of FIG. 5 and a second portion of the machine readable instructions represented by the flowcharts of FIG. 2 and FIG. 3 may be executed by the FPGA circuitry 600 of FIG. 6.

In some examples, the processor circuitry 412 of FIG. 4 may be in one or more packages. For example, the processor circuitry 500 of FIG. 5 and/or the FPGA circuitry 500 of FIG. 5 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that determine/predict an impact of a source code change on cloud infrastructure. The disclosed systems, methods, apparatus, and articles of manufacture improve the efficiency of using a computing device by providing cloud tenants information about any impacts that a source change may have on the tenant's infrastructure such that the tenant may determine whether the changes are suitable or whether the changes should be reconsidered. The disclosed systems, methods, apparatus, and articles of manufacture thereby allow a tenant to identify/predict any of a variety of effects/impacts such the change will have including effects on costs, effects on savings plan, effects on tenant policies, effects on equipment grouping costs, etc. Thus, the disclosed systems, methods, apparatus, and articles of manufacture improve the efficiency of using a computing device and are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to predict impact of a source code change on a cloud infrastructure are disclosed herein. Further examples and combinations thereof include the following:

Example methods, apparatus, systems, and articles of manufacture to determine an impact of a source code change on a cloud infrastructure are disclosed herein. Further examples and combinations thereof include the following:

Example 1 includes a system to determine an impact of a source code change on a cloud infrastructure, the system comprising an infrastructure difference identifier to identify a difference between a proposed infrastructure and an existing infrastructure of the cloud infrastructure, and an infrastructure analyzer to identify new infrastructure equipment to be added to the existing infrastructure based on the difference, obtain identities of at least some of the new infrastructure equipment that are candidates for right-sizing based on a infrastructure equipment grouping into which the at least some of the new infrastructure equipment is to be placed, and obtain information identifying a cost associated with different infrastructure equipment to be deployed in place of the candidates, the different infrastructure equipment being right-sized for the infrastructure equipment grouping, and generate a report identifying an amount of savings that can be achieved by deploying the different infrastructure equipment in place of the with new infrastructure equipment.

Example 2 includes the system of example 1, further including a infrastructure grouping analyzer to identify (i) the infrastructure equipment grouping into which at least one of the new infrastructure equipment is to be placed based on a tag associated with the at least one new infrastructure equipment, (ii) the candidates for right-sizing, and (iii) the different infrastructure equipment, the different infrastructure equipment identified based a comparison of a first equipment size of the at least one new infrastructure equipment with a second equipment size associated with one or more existing infrastructure equipment included in the infrastructure equipment grouping.

Example 3 includes the system of example 1, wherein the cloud infrastructure is a tenant cloud infrastructure provided by a cloud operator, the amount of savings that can be achieved by deploying the different infrastructure equipment in place of the new infrastructure equipment is a first amount of savings, and the system further including a savings plan analyzer to determine an existing rate paid by a cloud tenant to the cloud operator for operating the existing infrastructure of the tenant cloud, determine a changed rate, the changed rate to be paid by the cloud tenant to the cloud operator for the proposed infrastructure, the existing rate and the changed rate based on an agreement between the cloud tenant and the cloud operator, and determine a second amount of cost savings that can be achieved based on a comparison of the existing rate and the changed rate.

Example 4 includes the system of example 1, wherein the amount of savings that can be achieved by deploying the different infrastructure equipment in place of the new infrastructure equipment is a first amount of savings, the system further including a monthly cost analyzer to obtain a first periodical cost of operating the tenant cloud in the existing configuration, calculate a second periodical cost of operating the tenant cloud using the proposed infrastructure, and calculate a second amount of savings based on a comparison of the first periodical cost and the second periodical cost.

Example 5 includes the system of example 1, further including a source code controller to use a source code change to generate an infrastructure configuration file corresponding to the source code change, the infrastructure configuration file to identify a configuration of the proposed infrastructure.

Example 6 includes the system of example 5, wherein the infrastructure difference identifier uses the infrastructure configuration file corresponding to the proposed infrastructure and a configuration file corresponding to the existing infrastructure to identify the difference between a proposed infrastructure and an existing infrastructure of the cloud infrastructure.

Example 7 includes At least one non-transitory computer readable medium comprising computer readable instructions that, when executed, cause at least one processor to identify a difference between a proposed infrastructure of a tenant cloud and an existing infrastructure of the tenant cloud, identify new infrastructure equipment to be added to the existing infrastructure based on the difference between the proposed infrastructure and the existing infrastructure, obtain identities of at least some of the new infrastructure equipment that are candidates for right-sizing based on a infrastructure equipment grouping into which the at least some of the new infrastructure equipment is to be placed, obtain information identifying a cost associated with different infrastructure equipment to deploy in place of the candidates, the different infrastructure equipment being right-sized for the infrastructure equipment grouping, and generate a report identifying an amount of savings that can be achieved by deploying the different infrastructure equipment in place of the new infrastructure equipment.

Example 8 includes the at least one non-transitory computer readable medium of example 7 wherein the computer readable instructions, when executed, further cause the at least one processor to identify (i) the infrastructure equipment grouping into which the new infrastructure equipment is to be placed based on tags associated with the new infrastructure equipment, (ii) the candidates for right-sizing, and (iii) the different infrastructure equipment, the different infrastructure equipment identified based a comparison of a first equipment size of new infrastructure equipment with a second equipment size associated with existing infrastructure equipment included in the infrastructure equipment grouping.

Example 9 includes the at least one non-transitory computer readable medium of example 7, wherein the tenant cloud is provided by a cloud operator, the amount of savings that can be achieved by deploying the different infrastructure equipment in place of the new infrastructure equipment is a first amount of savings, and the computer readable instructions, when executed, further cause the at least one processor to determine an existing rate paid by a cloud tenant to the cloud operator for operating the existing infrastructure of the tenant cloud, determine a changed rate, the changed rate to be paid by the cloud tenant to the cloud operator for the proposed infrastructure, the existing rate and the changed rate based on an agreement between the cloud tenant and the cloud operator, and determine a second amount of cost savings that can be achieved based on a comparison of the existing rate and the changed rate.

Example 10 includes the at least one non-transitory computer readable medium of example 7, wherein the amount of savings that can be achieved by deploying the different infrastructure equipment in place of the new infrastructure equipment is a first amount of savings, and the computer readable instructions, when executed, further cause the at least one processor to obtain a first periodical cost of operating the tenant cloud in an existing infrastructure configuration, calculate a second periodical cost of operating the tenant cloud in a proposed infrastructure configuration, and calculate a second amount of savings based on a comparison of the first periodical cost and the second periodical cost.

Example 11 includes the at least one non-transitory computer readable medium of example 7, wherein the computer readable instructions, when executed, further cause the at least one processor to use a source code change to generate an infrastructure configuration file corresponding to the source code change, the infrastructure configuration file to identify a configuration of the proposed infrastructure.

Example 12 includes the at least one non-transitory computer readable medium of example 11, wherein the computer readable instructions, when executed, further cause the at least one processor to use the infrastructure configuration file corresponding to the proposed infrastructure and a configuration file corresponding to the existing infrastructure to determine the difference between a proposed infrastructure and an existing infrastructure of the tenant cloud.

Example 13 includes an apparatus to determine an impact of a source code change on a tenant cloud infrastructure, the apparatus comprising at least one memory, computer readable instructions, and at least one processor to execute the computer readable instructions to identify new infrastructure equipment to be added to an existing infrastructure of the tenant cloud infrastructure based on a proposed infrastructure modification, obtain identities of at least some of the new infrastructure equipment that are candidates for right-sizing based on a infrastructure equipment grouping into which the at least some of the new infrastructure equipment is to be placed, obtain information identifying a cost associated with different infrastructure equipment to deploy in place of the candidates, the different infrastructure equipment being right-sized for the infrastructure equipment grouping, and generate a report identifying an amount of savings that can be achieved by deploying the different infrastructure equipment in place of the new infrastructure equipment.

Example 14 includes the at least one non-transitory computer readable medium of example 13, wherein the computer readable instructions, when executed, further cause the at least one processor to identify (i) the infrastructure equipment grouping into which the new infrastructure equipment is to be placed based on a tag associated with the new infrastructure equipment, (ii) the candidates for right-sizing, and (iii) the different infrastructure equipment, the different infrastructure equipment identified based a comparison of a first equipment size of the new infrastructure equipment with a second equipment size associated with existing infrastructure equipment of the existing infrastructure included in the infrastructure equipment grouping.

Example 15 includes the at least one non-transitory computer readable medium of example 13, wherein the tenant cloud infrastructure is provided by a cloud operator, the amount of savings that can be achieved by deploying the different infrastructure equipment in place of the new infrastructure equipment is a first amount of savings, and the computer readable instructions, when executed, further cause the at least one processor to determine an existing rate paid by a tenant of the tenant cloud infrastructure to a cloud operator for operating the existing infrastructure, determine a changed rate, the changed rate to be paid by the cloud tenant to the cloud operator for the proposed infrastructure modification, the existing rate and the changed rate based on an agreement between the cloud tenant and the cloud operator, and determine a second amount of cost savings that can be achieved based on a comparison of the existing rate and the changed rate.

Example 16 includes the at least one non-transitory computer readable medium of example 13, wherein the amount of savings that can be achieved by deploying the different infrastructure equipment in place of the new infrastructure equipment is a first amount of savings, and the computer readable instructions, when executed, further cause the at least one processor to obtain a first periodical cost of operating the tenant cloud in an existing infrastructure configuration, calculate a second periodical cost of operating the tenant cloud using a proposed infrastructure configuration, the proposed infrastructure configuration based on the proposed infrastructure modification, and calculate a second amount of savings based on a comparison of the first periodical cost and the second periodical cost.

Example 17 includes the at least one non-transitory computer readable medium of example 13, wherein the computer readable instructions, when executed, further cause the at least one processor to use a source code change to generate an infrastructure configuration file corresponding to the source code change, the infrastructure configuration file to identify a configuration of the proposed infrastructure.

Example 18 includes the at least one non-transitory computer readable medium of example 17, wherein the instructions, when executed, further cause the at least one processor to determine the difference between a proposed infrastructure and an existing infrastructure of the cloud infrastructure based on the infrastructure configuration file corresponding to the proposed infrastructure and a configuration file corresponding to the existing infrastructure.

Example 19 includes a method to determine an impact of a source code change on a cloud infrastructure, the method comprising identifying, by executing an instruction with at least one processor, new infrastructure equipment to be added to an existing infrastructure of a tenant cloud based on proposed modification to the existing infrastructure, obtaining identities of at least some of the new infrastructure equipment that are candidates for right-sizing based on a infrastructure equipment grouping into which the at least some of the new infrastructure equipment is to be placed, obtaining information identifying a cost associated with different infrastructure equipment to deploy in place of the candidates, the different infrastructure equipment being right-sized for the grouping, and generating a report identifying an amount of savings that can be achieved by deploying the new infrastructure equipment in place of the different infrastructure equipment.

Example 20 includes the method of example 19, further including identifying (i) the infrastructure equipment grouping into which the new infrastructure equipment is to be placed based on a tag associated with the new infrastructure equipment, (ii) the candidates for right-sizing, and (iii) the different infrastructure equipment, the different infrastructure equipment identified based a comparison of a first equipment size of the new infrastructure equipment with a second equipment size of an existing infrastructure equipment included in the infrastructure equipment grouping.

The following claims are hereby incorporated into this Detailed Description by this reference, with each claim standing on its own as a separate embodiment of the present disclosure.

What is claimed is:

1. A system to determine an impact of a source code change on a cloud infrastructure, the system comprising:
an infrastructure difference identifier to identify a difference between a proposed infrastructure and an existing infrastructure of the cloud infrastructure; and
an infrastructure analyzer to:
identify new infrastructure equipment to be added to the existing infrastructure based on the difference,
obtain identities of at least some of the new infrastructure equipment that are candidates for right-sizing based on a infrastructure equipment grouping into which the at least some of the new infrastructure equipment is to be placed,
obtain information identifying a cost associated with different infrastructure equipment to be deployed in place of the candidates, the different infrastructure equipment being right-sized for the infrastructure equipment grouping; and
generate a report identifying an amount of savings that can be achieved by deploying the different infrastructure equipment in place of the with new infrastructure equipment.

2. The system of claim 1, further including an infrastructure grouping analyzer to identify: (i) the infrastructure equipment grouping into which at least one of the new infrastructure equipment is to be placed based on a tag associated with the at least one new infrastructure equipment, (ii) the candidates for right-sizing, and (iii) the different infrastructure equipment, the different infrastructure equipment identified based a comparison of a first equipment size of the at least one new infrastructure equipment with a second equipment size associated with one or more existing infrastructure equipment included in the infrastructure equipment grouping.

3. The system of claim 1, wherein the cloud infrastructure is a tenant cloud infrastructure provided by a cloud operator, the amount of savings that can be achieved by deploying the different infrastructure equipment in place of the new infrastructure equipment is a first amount of savings, and the system further including:
a savings plan analyzer to:
determine an existing rate paid by a cloud tenant to the cloud operator for operating the existing infrastructure of the tenant cloud,
determine a changed rate, the changed rate to be paid by the cloud tenant to the cloud operator for the proposed infrastructure, the existing rate and the changed rate based on an agreement between the cloud tenant and the cloud operator, and
determine a second amount of cost savings that can be achieved based on a comparison of the existing rate and the changed rate.

4. The system of claim 3, wherein the amount of savings that can be achieved by deploying the different infrastructure equipment in place of the new infrastructure equipment is a first amount of savings, the system further including a monthly cost analyzer to:
obtain a first periodical cost of operating the tenant cloud in the existing configuration;
calculate a second periodical cost of operating the tenant cloud using the proposed infrastructure; and
calculate a second amount of savings based on a comparison of the first periodical cost and the second periodical cost.

5. The system of claim 1, further including a source code controller to use a source code change to generate an infrastructure configuration file corresponding to the source code change, the infrastructure configuration file to identify a configuration of the proposed infrastructure.

6. The system of claim 5, wherein the infrastructure difference identifier uses the infrastructure configuration file corresponding to the proposed infrastructure and a configuration file corresponding to the existing infrastructure to identify the difference between a proposed infrastructure and an existing infrastructure of the cloud infrastructure.

7. At least one non-transitory computer readable medium comprising computer readable instructions that, when executed, cause at least one processor to:
identify a difference between a proposed infrastructure of a tenant cloud and an existing infrastructure of the tenant cloud;
identify new infrastructure equipment to be added to the existing infrastructure based on the difference between the proposed infrastructure and the existing infrastructure;
obtain identities of at least some of the new infrastructure equipment that are candidates for right-sizing based on a infrastructure equipment grouping into which the at least some of the new infrastructure equipment is to be placed,
obtain information identifying a cost associated with different infrastructure equipment to deploy in place of the candidates, the different infrastructure equipment being right-sized for the infrastructure equipment grouping; and
generate a report identifying an amount of savings that can be achieved by deploying the different infrastructure equipment in place of the new infrastructure equipment.

8. The at least one non-transitory computer readable medium of claim 7 wherein the computer readable instructions, when executed, further cause the at least one processor to identify: (i) the infrastructure equipment grouping into which the new infrastructure equipment is to be placed based on tags associated with the new infrastructure equipment, (ii) the candidates for right-sizing, and (iii) the different infrastructure equipment, the different infrastructure equipment identified based a comparison of a first equipment size of new infrastructure equipment with a second equipment size associated with existing infrastructure equipment included in the infrastructure equipment grouping.

9. The at least one non-transitory computer readable medium of claim 7, wherein the tenant cloud is provided by a cloud operator, the amount of savings that can be achieved by deploying the different infrastructure equipment in place of the new infrastructure equipment is a first amount of savings, and the computer readable instructions, when executed, further cause the at least one processor to:
determine an existing rate paid by a cloud tenant to the cloud operator for operating the existing infrastructure of the tenant cloud;
determine a changed rate, the changed rate to be paid by the cloud tenant to the cloud operator for the proposed infrastructure, the existing rate and the changed rate based on an agreement between the cloud tenant and the cloud operator; and
determine a second amount of cost savings that can be achieved based on a comparison of the existing rate and the changed rate.

10. The at least one non-transitory computer readable medium of claim 7, wherein the amount of savings that can be achieved by deploying the different infrastructure equipment in place of the new infrastructure equipment is a first amount of savings, and the computer readable instructions, when executed, further cause the at least one processor to:
obtain a first periodical cost of operating the tenant cloud in an existing infrastructure configuration;
calculate a second periodical cost of operating the tenant cloud in a proposed infrastructure configuration; and
calculate a second amount of savings based on a comparison of the first periodical cost and the second periodical cost.

11. The at least one non-transitory computer readable medium of claim 7, wherein the computer readable instructions, when executed, further cause the at least one processor to: use a source code change to generate an infrastructure configuration file corresponding to the source code change, the infrastructure configuration file to identify a configuration of the proposed infrastructure.

12. The at least one non-transitory computer readable medium of claim 11, wherein the computer readable instructions, when executed, further cause the at least one processor to use the infrastructure configuration file corresponding to the proposed infrastructure and a configuration file corresponding to the existing infrastructure to determine the difference between a proposed infrastructure and an existing infrastructure of the tenant cloud.

13. An apparatus to determine an impact of a source code change on a tenant cloud infrastructure, the apparatus comprising:
at least one memory;
computer readable instructions in the apparatus; and
at least one processor to execute the computer readable instructions to:
identify new infrastructure equipment to be added to an existing infrastructure of the tenant cloud infrastructure based on a proposed infrastructure modification;
obtain identities of at least some of the new infrastructure equipment that are candidates for right-sizing based on a infrastructure equipment grouping into which the at least some of the new infrastructure equipment is to be placed,
obtain information identifying a cost associated with different infrastructure equipment to deploy in place of the candidates, the different infrastructure equipment being right-sized for the infrastructure equipment grouping; and
generate a report identifying an amount of savings that can be achieved by deploying the different infrastructure equipment in place of the new infrastructure equipment.

14. The at least one non-transitory computer readable medium of claim 13, wherein the computer readable instructions, when executed, further cause the at least one processor to identify: (i) the infrastructure equipment grouping into which the new infrastructure equipment is to be placed based on a tag associated with the new infrastructure equipment, (ii) the candidates for right-sizing, and (iii) the different infrastructure equipment, the different infrastructure equipment identified based a comparison of a first equipment size of the new infrastructure equipment with a second equipment size associated with existing infrastructure equipment of the existing infrastructure included in the infrastructure equipment grouping.

15. The at least one non-transitory computer readable medium of claim 13, wherein the tenant cloud infrastructure is provided by a cloud operator, the amount of savings that can be achieved by deploying the different infrastructure equipment in place of the new infrastructure equipment is a first amount of savings, and the computer readable instructions, when executed, further cause the at least one processor to:
determine an existing rate paid by a tenant of the tenant cloud infrastructure to a cloud operator for operating the existing infrastructure;
determine a changed rate, the changed rate to be paid by the cloud tenant to the cloud operator for the proposed infrastructure modification, the existing rate and the changed rate based on an agreement between the cloud tenant and the cloud operator; and
determine a second amount of cost savings that can be achieved based on a comparison of the existing rate and the changed rate.

16. The at least one non-transitory computer readable medium of claim 13, wherein the amount of savings that can be achieved by deploying the different infrastructure equipment in place of the new infrastructure equipment is a first amount of savings, and the computer readable instructions, when executed, further cause the at least one processor to:
obtain a first periodical cost of operating the tenant cloud in an existing infrastructure configuration;
calculate a second periodical cost of operating the tenant cloud using a proposed infrastructure configuration, the proposed infrastructure configuration based on the proposed infrastructure modification; and
calculate a second amount of savings based on a comparison of the first periodical cost and the second periodical cost.

17. The at least one non-transitory computer readable medium of claim 13, wherein the computer readable instructions, when executed, further cause the at least one processor to use a source code change to generate an infrastructure configuration file corresponding to the source code change, the infrastructure configuration file to identify a configuration of the proposed infrastructure.

18. The at least one non-transitory computer readable medium of claim 17, wherein the instructions, when executed, further cause the at least one processor to determine the difference between a proposed infrastructure and an existing infrastructure of the cloud infrastructure based on the infrastructure configuration file corresponding to the proposed infrastructure and a configuration file corresponding to the existing infrastructure.

19. A method to determine an impact of a source code change on a cloud infrastructure, the method comprising:
identifying, by executing an instruction with at least one processor, new infrastructure equipment to be added to an existing infrastructure of a tenant cloud based on proposed modification to the existing infrastructure;
obtaining identities of at least some of the new infrastructure equipment that are candidates for right-sizing based on a infrastructure equipment grouping into which the at least some of the new infrastructure equipment is to be placed,
obtaining information identifying a cost associated with different infrastructure equipment to deploy in place of the candidates, the different infrastructure equipment being right-sized for the grouping; and
generating a report identifying an amount of savings that can be achieved by deploying the new infrastructure equipment in place of the different infrastructure equipment.

20. The method of claim 19, further including identifying: (i) the infrastructure equipment grouping into which the new infrastructure equipment is to be placed based on a tag associated with the new infrastructure equipment, (ii) the candidates for right-sizing, and (iii) the different infrastructure equipment, the different infrastructure equipment identified based a comparison of a first equipment size of the new infrastructure equipment with a second equipment size of an existing infrastructure equipment included in the infrastructure equipment grouping.
